(19) United States
(12) Patent Application Publication
(10) Pub. No.: US 2006/0159023 A1
(43) Pub. Date: Jul. 20, 2006

(54) CRC error history mechanism

(75) Inventors: Mark J. Hickey, Rochester, MN (US); Robert A. Shearer, Rochester, MN (US); Alfred T. Watson III, Rochester, MN (US)

Correspondence Address: IBM CORPORATION;DEPT 917, 3605 HIGHWAY 52 NORTH, ROCHESTER, NY, 55901-7829, US

(73) Assignee: International Business Machines Corporation, Armonk, NY (US)

(21) Appl. No.: 11/035,558

(22) Filed: Jan. 14, 2005

(51) Int. Cl. H04L 12/26; H04J 3/14; H04J 1/16; H04L 1/00

(52) U.S. Cl. 370/241

(57) ABSTRACT

Methods and apparatuses that may be utilized to dynamically train communications links between two or more devices based on an error detection history are provided. The error detection history may be based on error detection value comparisons (e.g., CRCs) for a sequence of received packets. According to some embodiments, packets may be accepted only if a number (N) of successive packets have been received without errors, while link training may be automatically initiated only if a number (P) of successive packets have been received with errors.

### CROSS-REFERENCE TO RELATED APPLICATIONS

This application contains subject matter which is related to the subject matter of commonly owned, co-pending U.S. Application entitled “AUTOMATIC HARDWARE DATA LINK INITIALIZATION,” Ser. No. 10/932,728, filed on Sep. 2, 2004, hereby incorporated herein by reference in its entirety.

### BACKGROUND OF THE INVENTION

1. Field of the Invention

The present invention generally relates to exchanging packets of data on a bus between two devices and, more particularly to dynamically training components in communications link between the two devices.

2. Description of the Related Art

A system on a chip (SOC) generally includes one or more integrated processor cores, some type of embedded memory, such as a cache shared between the processors cores, and peripheral interfaces, such as external bus interfaces, on a single chip to form a complete (or nearly complete) system. The external bus interface is often used to pass data in packets over an external bus between these systems and an external device, such as an external memory controller or graphics processing unit (GPU). To increase system performance, the data transfer rates between such devices has been steadily increasing over the years.

Unfortunately, as the data transfer rate between devices increases, bytes of data transferred between devices may become skewed for different reasons, such as internal capacitance, differences in drivers and/or receivers used on the different devices, different routing of internal bus paths, and the like. Such skew may cause data transferred from one device to be read erroneously by the other device. This misalignment can lead to incorrectly assembled data fed into the processor cores, which may have unpredictable results and possibly catastrophic effects.

One approach to minimize this type of skew is to perform some type of training under software control, whereby internal drivers and/or receivers of one device may be adjusted while the other device outputs specially designed data packets (e.g., having known data patterns). Unfortunately, there may be substantial delay (e.g., after a system power-on cycle) before such software code can be executed. Further, performing such training in software may undesirably delay or interrupt the execution of actual application code.

It some cases, in order to avoid latency caused by unnecessary training, it may be beneficial to perform this training only when necessary, for example, as indicated by transmission errors detected when performing some type of error detection algorithm, such as a cyclic redundancy check (CRC). However, initiating training upon the detection of a single error may lead to unnecessary link training, if the error is due to a transient occurrence that does not result in consistent errors.

Accordingly, what is needed are methods and apparatus for automatically (dynamically) training and activating communications links between devices, preferably based on a history of error detection (e.g., based on multiple packets).

### SUMMARY OF THE INVENTION

The present invention generally provides methods and apparatuses for automatically initiating training of a communications link based on an error detection history.

One embodiment provides a method of training a local device for communication with a remote device over a communications link. The method generally includes, under hardware control, monitoring incoming data packets for errors, and maintaining a history of errors for a plurality of incoming data packets. Training of the communications link may be automatically initiated if the history of errors indicates a predetermined amount of errors in the incoming data packets have been detected.

Another embodiment provides a self-training bus interface for use in communicating between a first device containing the bus interface and a second device over a communications link generally including receive logic and a link state machine. The receive logic is generally configured to maintain a history of comparisons of checksums calculated for packets received from the second device and provide a first signal whose assertion is indicative of a first number N of consecutively received packets with good checksums and a second signal whose assertion is indicative of a second number P of consecutively received packets with bad checksums. The link state machine is generally configured to place the first device in a link active state if the first signal is asserted and automatically initiate link training if the second signal is asserted.

Another embodiment provides a system generally including a bus having a plurality of parallel bit lines, a first processing device, and a second processing device coupled with the first processing device via the bus. A self-training bus interface on each of the first and second processing devices is generally configured to automatically initiate transmit link training wherein synchronization packets are transmitted to the other device, based on a history of checksum errors for packets received from the other device.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system including a central processing unit (CPU), in which embodiments of the present invention may be utilized.

FIGS. 2A-2C illustrate block diagrams of a communications interface in various functional states, according to one embodiment of the present invention.

FIG. 3 is a flow diagram of exemplary operations for automatic link training based on an error detection history, according to one embodiment of the present invention.

FIG. 4 is a block diagram of receive logic with a programmable mechanism to monitor error detection history, according to one embodiment of the present invention.

FIGS. 5A and 5B illustrate exemplary logic circuits for generating signals based on monitored error detection history, according to one embodiment of the present invention.

### DETAILED DESCRIPTION OF THE PREFERRED EMBODIMENTS

The principles of the present invention provide for methods and apparatuses that may be utilized to dynamically train communications links between two or more devices based on an error detection history. The error detection history may be based on error detection value comparisons (e.g., CRCs) for a sequence of received packets. According to some embodiments, packets may be accepted only if a number (N) of successive packets have been received without errors, while link training may be automatically initiated only if a number (P) of successive packets have been received with errors. As will be described in greater detail below, for some embodiments, the values N and P may be adjusted (e.g., via a programmable control register) to optimize system performance.

As used herein, the term state machine generally refers to an object in a system that goes through a defined sequence of states in response to various events, with each state often indicated by a specific observable action, such as the generation of a signal. Embodiments of the present invention will be described with reference to state machines implemented as hardware components that respond to various events, typically with the generation of one or more signals used to control the behavior of some other component. However, various behaviors of the state machines may be determined by software-controlled registers, such as registers used to hold adjustable threshold counter values or time-out periods. CRC error detection algorithms are described as a specific, but not limiting, example of a type of error detection algorithm that may be utilized. However, one skilled in the art will recognize that any other suitable type error detection algorithm that generates a value based on the content of a data packet may also be utilized.

Further, in the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### An Exemplary System

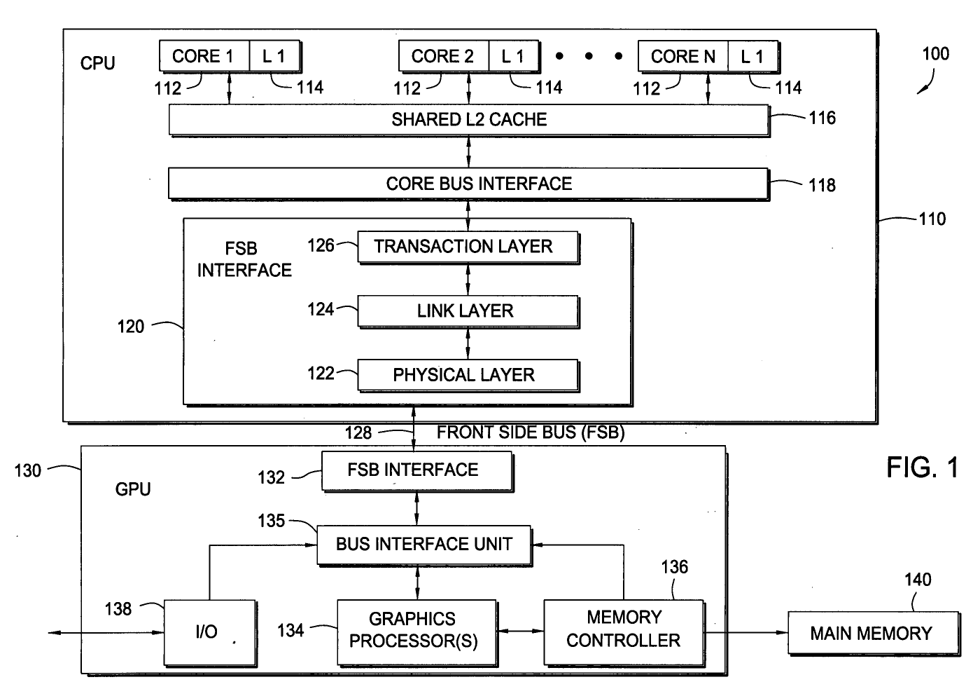

FIG. 1 illustrates an exemplary computer system 100 including a central processing unit (CPU) 110, in which embodiments of the present invention may be utilized. As illustrated, the CPU 110 may include one or more processor cores 112, which may each include any number of different type function units including, but not limited to arithmetic logic units (ALUs), floating point units (FPUs), and single instruction multiple data (SIMD) units. Examples of CPUs utilizing multiple processor cores include the Power PC line of CPUs, available from International Business Machines (IBM).

As illustrated, each processor core 112 may have access to its own primary (L1) cache 114, as well as a larger shared secondary (L2) cache 116. In general, copies of data utilized by the processor cores 112 may be stored locally in the L2 cache 116, preventing or reducing the number of relatively slower accesses to external main memory 140. Similarly, data utilized often by a processor core may be stored in its L1 cache 114, preventing or reducing the number of relatively slower accesses to the L2 cache 116.

The CPU 110 may communicate with external devices, such as a graphics processing unit (GPU) 130 and/or a memory controller 136 via a system or frontside bus (FSB) 128. The CPU 110 may include an FSB interface 120 to pass data between the external devices and the processing cores 112 (through the L2 cache) via the FSB 128. An FSB interface 132 on the GPU 130 may have similar components as the FSB interface 120, configured to exchange data with one or more graphics processors 134, input output (I/O) unit 138, and the memory controller 136 (illustratively shown as integrated with the GPU 130).

As illustrated, the FSB interface 120 may include a physical layer 122, link layer 124, and transaction layer 126. The physical layer 122 may include hardware components for implementing the hardware protocol necessary for receiving and sending data over the FSB 128. The physical layer 122 may exchange data with the link layer 124 which may format data received from or to be sent to the transaction layer 126. The transaction layer 126 may exchange data with the processor cores 112 via a core bus interface (CBI) 118. For some embodiments, data may be sent over the FSB as packets. Therefore, the link layer 124 may contain circuitry (not shown) configured to encode into packets or “packetize” data received from the transaction layer 126 and to decode packets of data received from the physical layer 122.

### Automatic Link Initialization

As previously described, bytes of data transferred over the FSB 128 between the CPU 110 and GPU 130 (or any other type of high speed interface between devices) may become skewed due to various factors, such as internal capacitance, differences in internal components (e.g., drivers and receivers), different routing of the internal data paths, thermal drift, and the like. In order to compensate for such skew, both devices may utilize some type of mechanism (e.g., the mechanisms may work together) to automatically train and activate the communications links.

Such mechanisms are described in the commonly owned, co-pending U.S. Application entitled “AUTOMATIC HARDWARE DATA LINK INITIALIZATION USING MULTIPLE STATE MACHINES,” Ser. No. 10/932,728, filed on Sep. 2, 2004, hereby incorporated herein by reference in its entirety. The mechanisms described therein may be utilized to achieve and maintain synchronization between both sides of the link (also referred to herein as link training), including a handshaking protocol where each device can indicate to the other it is synchronized.

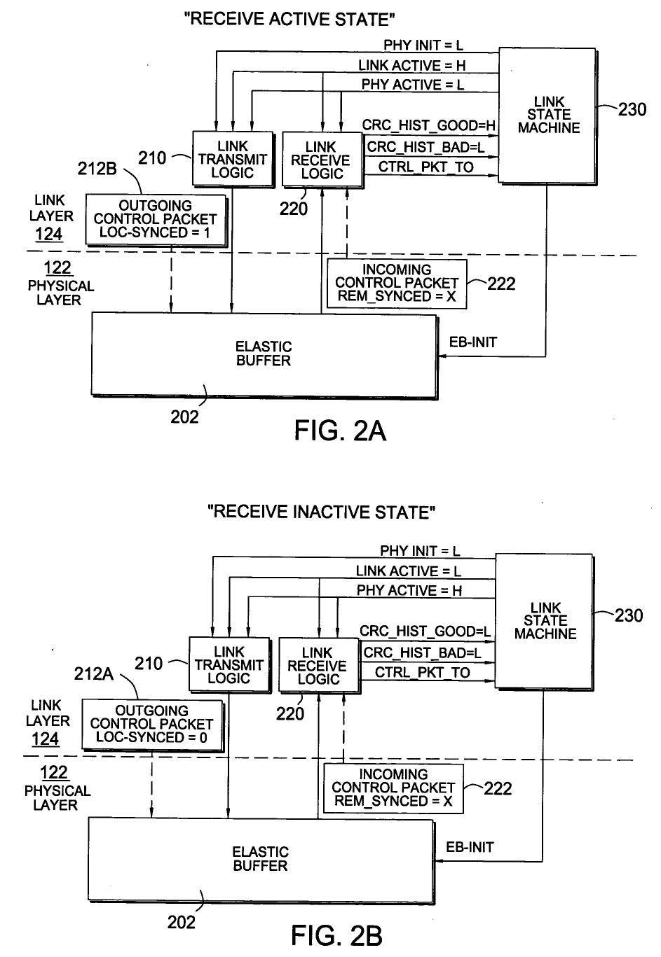

FIGS. 2A-2C illustrate such a mechanism, in which the link layer 124 may include one or more state machines 230 generally configured to monitor the status of the local physical layer 122, as well as a physical layer of the remote device with which the local device communicating (e.g., a physical layer in the FSB interface 132 of the GPU 130 shown in FIG. 1). While only one side of a communications link is shown (the CPU 120 side), it should be understood that similar operations may be performed on the other side of the link (e.g., the GPU 130 side). As illustrated, the state machine 230 may also monitor and control link transmit and receive logic 210 and 220, respectively, in the link layer 124, as well as an elastic buffer 202 used to hold data transferred to and from the link layer 124. In general, the term elastic buffer refers to a buffer that has an adjustable size and/or delay to hold varying amounts of data for varying amounts of time, depending on how rapidly the link layer is able to fill or unload data.

The link state machine 230 may assert various signals to indicate various states, for example, including a physical layer initialization or training state (PHY_INIT), an active state where packets are received (LINK_ACTIVE) and a physical layer active (PHY_ACTIVE) state. In general, the PHY_INIT state may indicate the physical layer is undergoing link training, while the LINK_ACTIVE state indicates both sides are trained and packets may be exchanged between devices freely.

While in the PHY_ACTIVE state, the state machine 230 may assert a PHY_ACTIVE signal to the Link Receive and Transmit logic 210 and 220. The PHY_ACTIVE signal may indicate to the Link Receive logic 220 that it may begin receive training by monitoring for incoming control packets 222. The PHY_ACTIVE signal may also indicate to the Transmit Receive logic 210 that the receive link is being trained and that a LOCAL_SYNCED bit in all outgoing control packets 212_{A} should be de-asserted (LOCAL_SYNCED=0), signaling the link logic on the other device that it should start sending Phy Sync packets. Incoming control packets 222 may have a similar bit (REMOTE_SYNCED) indicative of whether the receive link of the remote device is being trained.

### Dynamic Link Training Based on Error History

The link receive logic 220 may also generate other control signals, illustratively CRC_HISTORY_GOOD and CRC_HISTORY_BAD, indicative of a monitored error detection history, which may be used to automatically control and initiate link training. The link receive logic 220 may calculate checksums on incoming control packets 222 and compare the calculated checksums to checksums sent with the control packets 222. In other words, the incoming control packets 222 may contain checksums generated at the remote device prior to transmission. As used herein, the term checksum generally refers to any type of error correction code calculated on the basis of the contents of a data packet, and may be calculated using any suitable algorithm, such as a simple sum of bytes, a cyclic redundancy check (CRC) algorithm, or some type of hash function.

For some embodiments, the link receive logic 220 may maintain a history of these checksum comparisons, for example, as a bit string with each bit indicating whether a checksum comparison for a string of successive control packets failed or succeeded (e.g., with a bit cleared to indicate a failure or set to indicate a success). The link receive logic 220 may then generate the CRC_HISTORY_GOOD and CRC_HISTORY_BAD signals.based on this history, which, in some cases, may prompt the link state machine 230 to transition to another state.

For example, as illustrated in Table I below, the device may be placed in a Link Active state, able to accept packets if the CRC_HISTORY_GOOD signal

| CRC History | | | |
|---|---|---|---|
| Status | Accept Packets | Monitor CRC | Retrain |
| Good | Yes | Yes | No |
| Not Good | No | Yes | No |
| Bad | No | Yes | Yes |

indicates a number of consecutive packets with good checksums have been received. For some embodiments, if any one of the number of consecutive packets has a bad checksum, the device may be placed in a Link Inactive state, where the device (at least temporarily) does not accept packets. If a number of consecutive packets are again received with good checksums, the device may transition back to the Link Active state. On the other hand, if a number of consecutive packets are received with bad checksums, training of the communication link for the device may be automatically initiated.

The LINK_ACTIVE state is illustrated in FIG. 2A, with the CRC_HISTORY_GOOD signal asserted (illustratively a logic high), the CRC_HISTORY_BAD signal de-asserted (illustratively a logic low), and the LINK_ACTIVE signal asserted (illustratively a logic high). A link inactive state (packets not accepted) is illustrated in FIG. 2A, with the CRC_HISTORY_GOOD signal de-asserted, the CRC_HISTORY_BAD signal de-asserted, and the LINK_ACTIVE signal de-asserted. The PHY_INIT (or link training) state is illustrated in FIG. 2C, with the CRC_HISTORY_GOOD signal de-asserted, the CRC_HISTORY_BAD signal asserted, the LINK_ACTIVE signal de-asserted, and the PHY_INIT signal asserted.

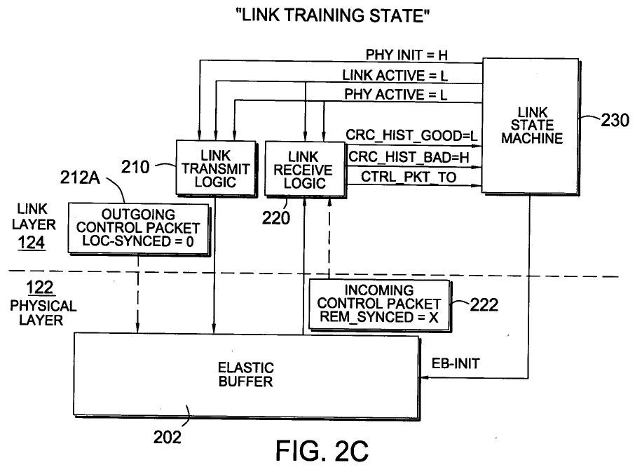

FIG. 3 illustrates exemplary operations 300 that may be performed, for example, by logic in the state machine 230, in order to dynamically transition into various states based on a monitored error history. The operations 300 begin, at step 302, by monitoring incoming data packets and keeping a history of CRC values. If N consecutive good CRC values are detected, as determined at step 304, packets are accepted, at step 306. This situation corresponds to the Link Active state illustrated in FIG. 2A.

If N consecutive good CRC values are not detected, packets are not accepted, at step 308. This situation corresponds to the Link Inactive state illustrated in FIG. 2B. It should be noted that this state may be (at least temporarily) entered when a single CRC error is detected, but may be exited if N consecutive good CRC values are detected. On the other hand, if P bad CRC values are detected, link training is automatically initiated, at step 312. This situation corresponds to the Link Training state illustrated in FIG. 2C.

### Exemplary Logic Diagrams

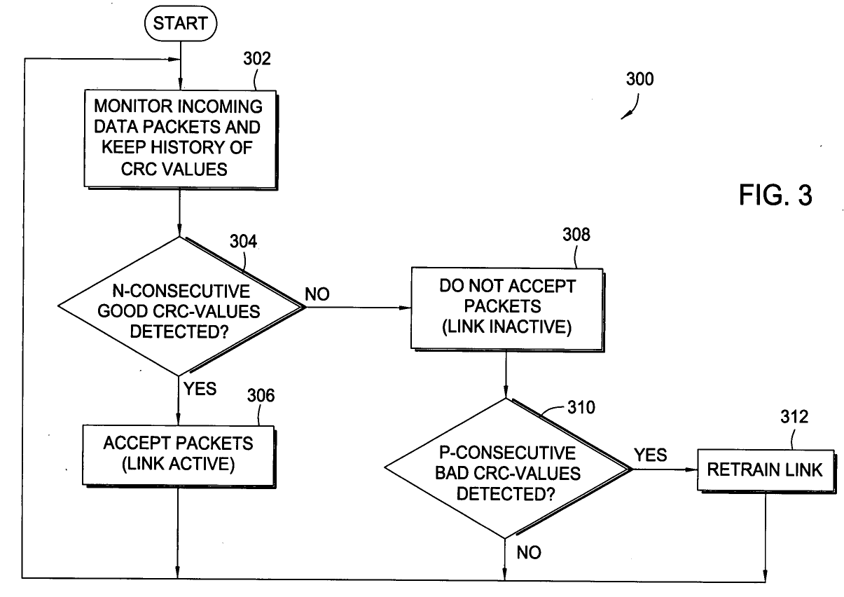

FIG. 4 illustrates exemplary logic circuitry that may be included in link receive logic 220 to maintain a history of checksum errors. As illustrated, the link receive logic 220 may include error checking logic 410, for example, configured to compare a CRC value contained in an incoming data packet with a CRC value calculated on the remainder of the packet. The error checking logic 410 may output a result of the comparison (e.g., 1 for good and 0 for bad) to a shift register 412.

With each new incoming packet, values in the shift register 412 may be shifted over one position. The contents of the shift register 412 may be applied to a CRC history signal generator circuit 420 configured to generate the CRC_HISTORY_GOOD and CRC_HISTORY_BAD signals accordingly. As previously described, the CRC_HISTORY_GOOD may be asserted if N consecutive packets with good checksums have been received, while CRC_HISTORY_BAD may be asserted if P consecutive packets with bad checksums have been received.

The values for N and P may be the same or different and, for some embodiments, may be programmable, for example, via a control register 422.

Setting N and P to relatively high values may allow checksums with relatively low error coverage (e.g., CRCs with a relatively low number of bits) to be efficiently utilized. Circuitry to implement such low coverage CRCs may operate faster and be less complex than circuitry to implement CRCs with larger number of bits.

For some embodiments, the control register 422 may allow different values to be specified for N and P which may allow automatic link training to be optimized based on particular system characteristics. For example, if a relatively large number of bus errors is expected, N may be set to a larger value than P, leading to a greater initial latency before accepting packets (as more consecutive good packets are required) and more frequent link training (as fewer consecutive bad packets are required) in an effort to provide more stable communications. On the other hand, if a relatively small number of bus errors is expected, N may be set to a smaller value than P, leading to a reduced initial latency before accepting packets (as less consecutive good packets are required) and less frequent link training (as more consecutive bad packets are required).

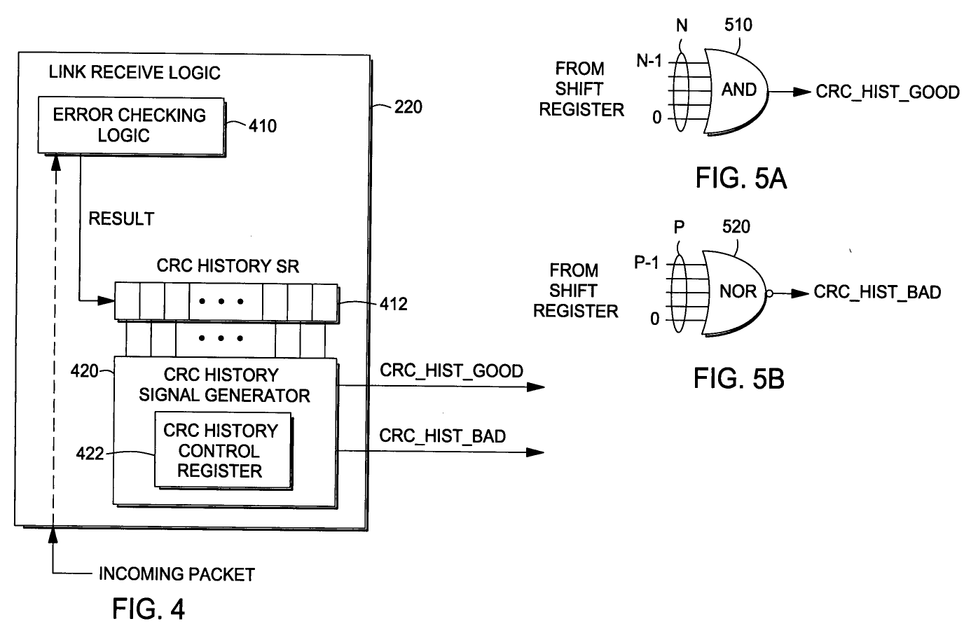

FIGS. 5A and 5B illustrate exemplary logic circuits for generating signals based on monitored error detection history, according to one embodiment of the present invention. As illustrated in FIG. 5A, assuming a high logic value represents a good checksum value, the CRC_HISTORY_GOOD signal may be generated by an N-input AND gate 510. The AND gate may accept N bit values from the shift register 412, with a logical low value in any bit resulting in de-assertion of CRC_HISTORY_GOOD. As illustrated in FIG. 5B, again assuming a high logic value represents a good checksum value, the CRC_HISTORY_BAD signal may be generated by an P-input NOR gate 520. The NOR gate may accept N bit values from the shift register 412, with a logical high value in any bit resulting in de-assertion of CRC_HISTORY_BAD.

As previously described, programmable values for N and P may determine how many bit values from the shift register 412 are applied to the logic gates 510 and 520, respectively. For some embodiments, the gates 510 and 520 may have inputs for each of the positions in the shift register 412. Additional circuitry may be included to pull unused bits high (for the AND gate 510) or low (for the NOR gate 520).

While specific embodiments have been described above that require a number (N or P) of consecutive packets to be received with good or bad checksums before asserting either CRC_HISTORY_GOOD or CRC_HISTORY_BAD, respectively, other embodiments may not have such a requirement. For example, other embodiments may automatically control link training in a similar manner, but based on a percentage or threshold sum of good or bad packets. In other words, if a given threshold number or running percentage or average of a sampled group of received packets have good or bad packets, CRC_HISTORY_GOOD or CRC_HISTORY_BAD may be set accordingly.

### CONCLUSION

By maintaining a history of checksum values, dynamic communications link training may be automatically controlled. This approach not only simplifies link training, but may provide a robust and efficient system where the training can be done only when needed, as indicated by the checksum history. Further, the checksum history provides an amount of hysteresis, allowing link problems to be quickly detected, without transient errors causing the link to be retrained.

While the foregoing is directed to embodiments of the present invention, other and further embodiments of the invention may be devised without departing from the basic scope thereof, and the scope thereof is determined by the claims that follow.

What is claimed is:

1. A method of training a local device for communication with a remote device over a communications link, comprising, under hardware control:
monitoring incoming data packets for errors;
maintaining a history of errors for a plurality of incoming data packets; and
automatically initiating training of the communications link if the history of errors indicates a predetermined amount of errors in the incoming data packets have been detected.

2. The method of claim 1, wherein monitoring incoming data packets for errors comprises comparing checksums contained in the incoming data packets against checksums calculated on remaining portions of the incoming data packets.

3. The method of claim 2, wherein the checksums comprise cyclic-redundancy-check (CRC) values.

4. The method of claim 2, wherein maintaining a history of errors for a plurality of incoming data packets comprises recording the results of checksum comparisons for a plurality of consecutive incoming data packets.

5. The method of claim 4, wherein recording the results of checksum comparisons for a plurality of consecutive incoming data packets comprises:
asserting a first signal if the checksum comparisons for N consecutive incoming data packets indicate no errors; and
asserting a second signal if the checksum comparisons for P consecutive incoming data packets indicate errors.

6. The method of claim 5, comprising automatically initiating training of the communications link in response to assertion of the second signal.

7. The method of claim 5, wherein values for N and P are programmable via a control register.

8. The method of claim 7, wherein the values for N and P may be programmed to be different.

9. The method of claim 5, comprising accepting incoming data packets only if the first signal is asserted.

10. A self-training bus interface for use in communicating between a first device containing the bus interface and a second device over a communications link, comprising:
receive logic configured to maintain a history of comparisons of checksums calculated for packets received from the second device and provide a first signal whose assertion is indicative of a first number N of consecutively received packets with good checksums and a second signal whose assertion is indicative of a second number P of consecutively received packets with bad checksums; and
a link state machine configured to place the first device in a link active state if the first signal is asserted and automatically initiate link training if the second signal is asserted.

11. The bus interface of claim 10, wherein the first and second numbers are selectable via programmable control register.

12. The bus interface of claim 10, wherein the receive logic is configured to maintain the history of checksum comparisons as bit values in a shift register.

13. The bus interface of claim 12, wherein the receive logic comprises logic circuitry configured to generate the first and second signals based on bit values in the shift register.

14. The bus interface of claim 13, wherein the logic circuitry comprises:
a first AND gate to generate the first signal based on N bit values of the shift register; and
a second NOR gate to generate the second signal based on P bit values of the shift register.

15. A system, comprising:
a bus having a plurality of parallel bit lines;
a first processing device;
a second processing device coupled with the first processing device via the bus; and
a self-training bus interface on each of the first and second processing devices, the bus interface in each device configured to automatically initiate transmit link training wherein synchronization packets are transmitted to the other device, based on a history of checksum errors for packets received from the other device.

16. The system of claim 15, wherein the bus interface on each device is configured to record a history of checksum errors for a number of consecutively received incoming packets from the other device.

17. The system of claim 16, wherein the bus interface on each device is configured to record the history of checksum errors as bit values in a shift register.

18. The system of claim 16, wherein logic on the bus interface of at least one of the devices is configured to:
assert a first signal if N consecutive packets are received with good checksums; and
assert a second signal if P consecutive packets are received with bad checksums;
wherein assertion of the first signal allows the acceptance of packets and assertion of the second signal initiates link retraining.

19. The system of claim 18, wherein the values for N and P on at least one of the devices are programmable via a control register.

20. The system of claim 15, wherein the first processing device is a central processing unit (CPU) and the second processing device is a graphics processing unit (GPU).
